(19) United States
(12) Patent Application Publication
(10) Pub. No.: US 2015/0131413 A1
(43) Pub. Date: May 14, 2015

(54) TIMEPIECE COMPRISING A DECOUPLING BETWEEN THE ENERGY TRANSMISSION MEANS AND THE COUNTING MEANS

(71) Applicant: ETA SA Manufacture Horlogere Suisse, Grenchen (CH)

(72) Inventors: Jean-Luc HELFER, Le Landeron (CH); Pascal Winkler, Marin (CH); Thierry Conus, Lengnau (CH)

(73) Assignee: ETA SA Manufacture Horlogere Suisse, Grenchen (CH)

(21) Appl. No.: 14/527,062

(22) Filed: Oct. 29, 2014

(30) Foreign Application Priority Data
Nov. 13, 2013 (EP) 13192757.6

(51) Int. Cl. G04B 1/22; G04B 19/20; G04B 15/08; G04B 19/04

(52) U.S. Cl. CPC G04B 1/22; G04B 19/04; G04B 19/202; G04B 15/08
USPC 368/77; 368/62; 368/80

(57) ABSTRACT

The invention concerns a timepiece comprising a timepiece movement cooperating with a display device, the timepiece movement comprising a mechanical energy source and a system of energy transmission from the energy source to at least one resonator including a first distribution device controlled by the at least one resonator. According to the invention, the timepiece also comprises a counting system mounted between the at least one resonator and the display device, and including a second distribution device controlled by the at least one resonator and cooperating with the display device to uncouple the energy transmission means from the counting means.

This application claims priority from European Patent Application No. 13192757.6 filed Nov. 13, 2013, the entire disclosure of which is incorporated herein by reference.

### FIELD OF THE INVENTION

The invention concerns a timepiece comprising a decoupling between the means of transmitting energy to a resonator and the counting means of a timepiece.

### BACKGROUND OF THE INVENTION

In conventional watch movements, a going barrel provides mechanical energy to a going train meshing with a Swiss lever type escapement system which cooperates with a sprung balance resonator. Thus, conventionally, the escapement system makes it possible to transmit energy to the resonator, to count the back-and-forth movements of the resonator and to be highly resistant to shocks.

However, conventional timepiece movements do not permit the use of any type of oscillator or resonator and are intrinsically restricted to a frequency of a few hertz.

### SUMMARY OF THE INVENTION

It is an object of the present invention to overcome all or part of the aforementioned drawbacks by offering a timepiece that remains resistant to shocks whilst offering great technological freedom as regards the oscillator and the means of transmitting energy from the mechanical energy source.

To this end, the invention concerns a timepiece comprising a timepiece movement cooperating with a display device, the timepiece movement comprising a mechanical energy source and a system of transmitting energy from the energy source to at least one resonator, said energy transmission system including a first distribution device periodically transmitting mechanical energy from the mechanical energy source to said at least one resonator via the movements of said at least one resonator characterized in that the timepiece also comprises a counting system mounted between said at least one resonator and the display device, said counting system including a second distribution device cooperating with the display device and counting the movements of said at least one resonator in an independent manner relative to said first distribution device so as to render the energy transmission system totally independent of the counting system.

Advantageously, it is understood that the invention makes it possible to optimise the maintenance function separately from the counting function. Thus, the same movements of said at least one resonator are detected and used in two different locations in the timepiece, on the one hand, to periodically transmit power from the going barrel to the said at least one resonator by means of the first distribution device and, on the other hand, in a totally independent manner, to count said movements of said at least one resonator by means of the second distribution device. The timepiece may therefore include a great variety of technologies for the first distribution device, said at least one resonator or the oscillator (i.e. where the first distribution device and said at least one resonator are structurally inseparable).

It is in particular noted that the first distribution device may be directly or indirectly engaged with the mechanical energy source and that the technological freedom enjoyed by the device does not restrict the type of said at least one resonator with regard to its nature and frequency. Thus, even if the first distribution device is sensitive to shocks and temporarily fails to transmit energy to said at least one resonator, it is understood that, in the worst case, the mechanical energy source will be temporarily “emptied” into the energy transmission system without affecting the time display since, entirely independently, the second distribution device of the counting system will continue to count the movements of the said at least one resonator for transmission to the display device. This is why the counting system is preferably chosen for its shock resistance.

In accordance with other advantageous features of the invention:
the energy transmission system comprises a transmission train mounted between the energy source and the first distribution device;
the transmission train is formed by at least two wheel sets cooperating mechanically, for example by friction or meshing, in order to form gear reduction means;
the transmission train is formed by single reduction gear such as for example an epicyclic gear train or a strain wave gear train;
the first distribution device comprises coupling means making it possible, by the movement of said at least one resonator, to transmit part of the energy from the energy source;
the coupling means are of the magnetic type such as, for example, at least one permanent magnet mounted on said at least one resonator synchronising without contact a wheel cooperating, directly or indirectly, with an energy source;
the coupling means are of the electrostatic type such as, for example, at least one electret mounted on said at least one resonator and synchronising without contact a wheel cooperating, directly or indirectly, with an energy source;
the coupling means are formed by an escapement mechanism such as, for example, a Swiss lever, coaxial or detent escapement, the escapement mechanism comprising an escape wheel that cooperates, directly or indirectly, with the energy source;
said at least one resonator is of the inertia-elasticity type such as, for example, a sprung balance assembly, a vibrating strip or a tuning fork;
said at least one resonator comprises several resonators coupled together;
the first distribution device and said at least one resonator form a one-piece oscillator such as a Clifford type for example;
the counting system comprises a counting train mounted between the display device and the second distribution device;
the counting train is formed by at least two wheel sets cooperating mechanically in order to form reduction means;
the second distribution device comprises counting means for detecting the movements of said at least one resonator without transmitting energy to said at least one resonator;
the counting means are of a mechanical type, such as, for example, at least one drive lever cooperating with said at least one resonator and driving a wheel cooperating, directly or indirectly, with the display device, or with at least one click cooperating with said at least one resonator and driving a ratchet wheel cooperating, directly or indirectly, with the display device, or at least one escapement mechanism cooperating with said at least one resonator and driving a wheel cooperating, directly or indirectly, with the display device and a second mechanical energy source;
each mechanical energy source comprises means of accumulating energy by elastic deformation or by pneumatic storage;
the display device comprises a hand and/or disc type display member.

### BRIEF DESCRIPTION OF THE DRAWINGS

Other features and advantages will appear clearly from the following description, given by way of non-limiting illustration, with reference to the annexed drawings, in which:

FIG. 1 is a schematic diagram of a timepiece according to the invention;

FIGS. 2 to 5 are schematic views of four embodiments of a timepiece according to the invention.

### DETAILED DESCRIPTION OF PREFERRED EMBODIMENTS

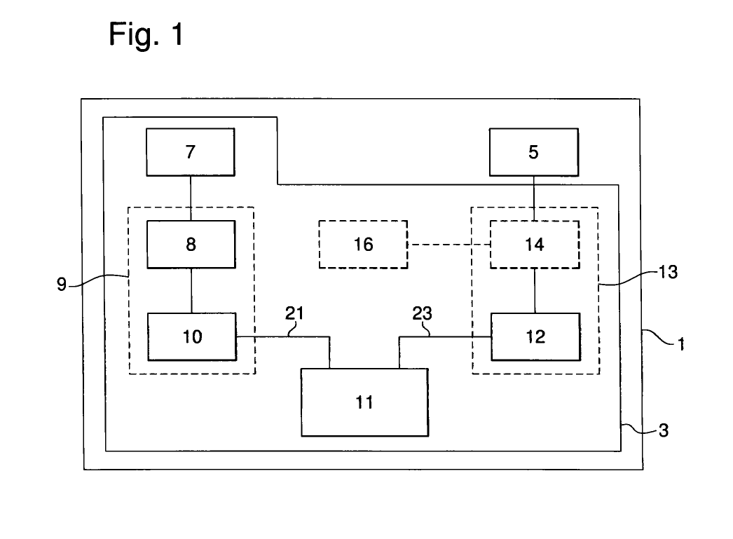

As shown in FIG. 1, the invention concerns a timepiece 1 comprising a timepiece movement 3 that cooperates with a time display device 5. The display device 5 may of course comprise any type of display member such as, for example, a hand and/or disc type display member. Moreover, display device 5 is not limited to displaying the time but may also display another time value such as a date or measured time, or even display a non-time related value such as a temperature, a pressure, a depth of immersion or an altitude.

Timepiece movement 3 comprises a mechanical energy source 7 and system 9 of energy transmission from mechanical energy source 7 to at least one resonator 11. The energy transmission system 9 includes at least one distribution device 10 controlled by said at least one resonator 11, that is to say that the movements of said at least one resonator 11 allow energy to be selectively received from mechanical energy source 7.

Advantageously according to the invention, timepiece 1 also includes a counting system 13 which is independent from transmission system 9 and mounted between said at least one resonator 11 and display device 5. Counting system 13 includes at least a second distribution device 12 which is independent from said at least one first distribution device 10 but still controlled by said at least one resonator 11, that is to say that the movements of said at least one resonator 11 are also selectively counted by second distribution device 12. Further, second distribution device 12 cooperates with display device 5 to decouple the means of energy transmission to said resonator 11 from the counting means from said at least one resonator 11, that is to say to render them totally independent of each other.

It is therefore understood that the same movements of said at least one resonator 11 are detected and used in two different locations in timepiece 1, on the one hand, to periodically transmit energy from the going barrel to said at least one resonator 11 by means of said at least one first distribution device 10 and, on the other hand in a totally independent manner, to count said movements of said at least one resonator 11 by means of said at least one second distribution device 12.

Advantageously according to the invention, it is understood that, even if first distribution device 10 is sensitive to shocks and temporarily fails to transmit energy to said at least one resonator 11, in the worst case, mechanical energy source 7 will be temporarily “emptied” into energy transmission system 9 without affecting time display 5 since, entirely independently, second distribution device 12 of counting system 13 will continue to count the movements of said at least one resonator 11 for transmission to the display device 5.

As a result, timepiece 1 may comprise a great variety of technologies for first distribution device 10 (type of cooperation with said at least one resonator 11, with or without contact, etc.), for said at least one resonator 11 (type, number, frequency, etc.) or for the oscillator (that is to say where first distribution device 10 and said at least one resonator 11 are structurally inseparable).

It is noted that first distribution device 10 may be directly or indirectly engaged with mechanical energy source 7 and that the technological freedom enjoyed thereby allows for a large number of different resonators 11. Thus, it is understood that energy transmission system 9 may optionally comprise a transmission train 8 mounted between energy source 7 and first distribution device 10.

Released from the counting function, energy transmission system 9 can therefore offer much greater freedom as to the choice of transmission train 8 used. In a first variant, transmission train 8 may, for example, be formed by at least two wheel sets cooperating mechanically in order to form reduction means. Thus, it is understood that such a first variant may comprise at least two wheel sets that cooperate differently from conventional going trains, for example, by friction, but meshing remains possible.

According to a second variant, transmission train 8 may be formed by a single reduction gear. This reduction gear may be, for example, a strain wave gear train 108 or an epicyclic gear train 208.

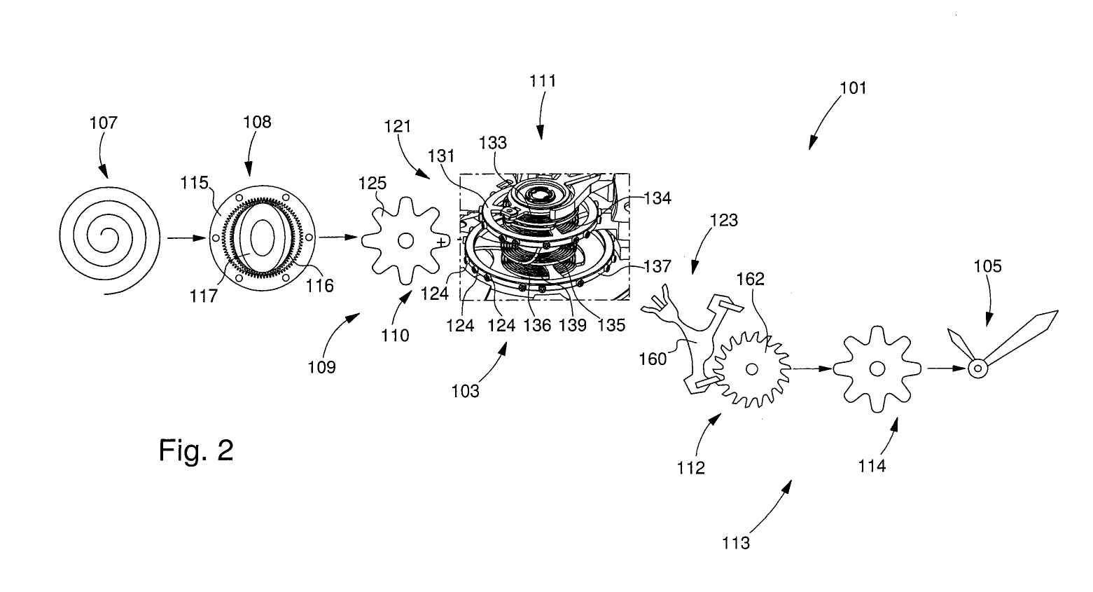

As shown in FIG. 2, a strain wave gear train 108 (also known as a “harmonic drive” from the eponymous company which developed it) is generally formed by a rigid ring 115 comprising at least one inner toothing, an elliptical wave generator 117 and a flexible ring 116 meshing with the inner teething of rigid ring 115 and in friction contact with the outer surface of wave generator 117 allowing for a higher reduction factor in a very compact space.

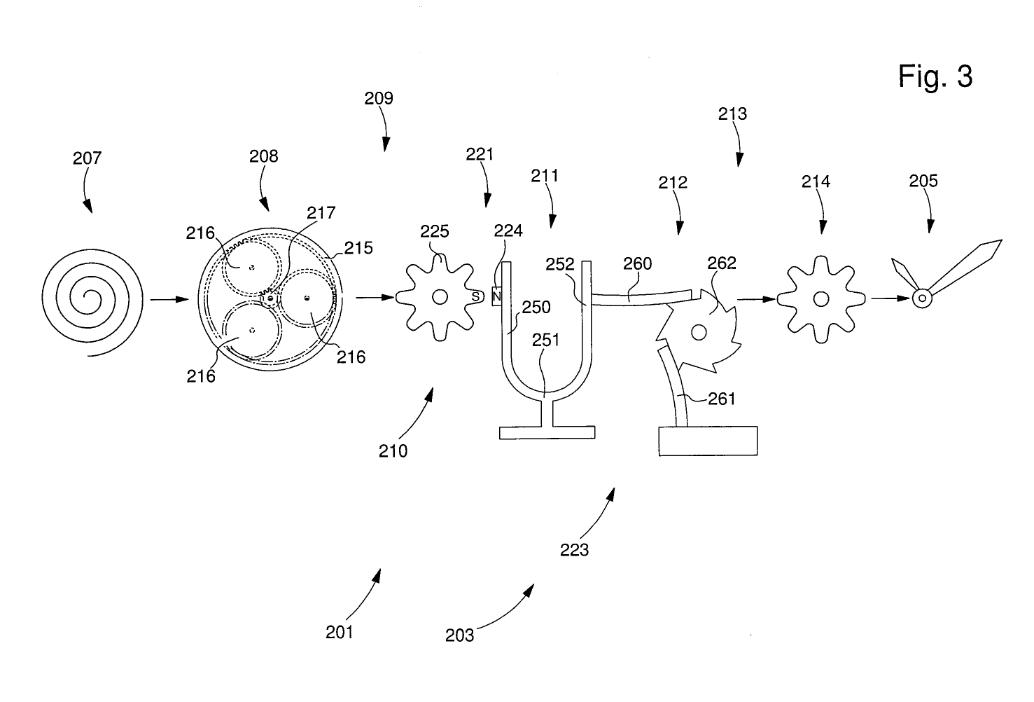

As shown in FIG. 3, an epicyclic gear train 208 is formed by an outer planetary gear 215 comprising at least one inner toothing, an inner planetary gear 217 comprising at least one outer toothing and at least one planetary wheel 216 (three are used in FIG. 3) meshing with the inner toothing of outer planetary gear 215 and the outer toothing of inner planetary gear 217 allowing for a large reduction factor.

Of course, transmission train 8 should not be limited to the two variants described above. Thus, transmission train 8 may comprise the following alterations according to the intended application and/or comprise other types of energy transmission.

Advantageously according to the invention, first distribution device 10 comprises coupling means 21 making it possible, by the movement of said at least one resonator 11, to transmit part of the energy from energy source 7.

According to a first variant, coupling means 21 may be of the magnetic type. By way of example illustrated in FIG. 3, the magnetic coupling means 221 may be formed by at least one permanent magnet 224 mounted on said at least one resonator 211 synchronising without contact a wheel 225 cooperating, directly or indirectly (indirectly through the gear train 208 in the case of FIG. 3), with energy source 207.

According to a second variant, coupling means 21 may be of the electrostatic type. By way of example illustrated in FIG. 2, electrostatic coupling means 121 may be formed by at least one electret 124 mounted on said at least one resonator 111 and synchronising without contact a selectively polarised wheel 125 cooperating, directly or indirectly (indirectly through gear train 108 in the case of FIG. 2), with energy source 107.

According to a third variant, coupling means 21 may be formed by an escapement mechanism. The escapement mechanism may then be a Swiss lever, coaxial or detent escapement, and comprise an escape wheel that cooperates, directly or indirectly, with the energy source.

Of course, first distribution device 10 should not be limited to the first, second or third variants described above. Thus, distribution device 10 may comprise the following modifications according to the intended application and/or comprise other types of energy transmission.

Advantageously according to the invention, said at least one resonator 11 may be of the inertia-elasticity type. By way of example, said at least one resonator 11 of the inertia-elasticity type may be a sprung balance assembly 311, a vibrating strip or a tuning fork 211.

It is also understood that said at least one resonator 11 may also comprise several resonators coupled together. By way of example shown in FIG. 2, an assembly 111 is used, comprising two sprung balance resonators as disclosed in EP Patent No 2,141,555 incorporated by reference into this description. Assembly 111 comprises a first balance 131 cooperating with a first balance spring 133 and a second balance 137 cooperating with a second balance spring 139. Each sprung balance resonator is constructed to have a different frequency and is synchronised with the other by means of a third helical spring formed by a first spiral spring 134 connected to the first resonator and is extended by a raised outer coil 135 to a second spiral spring 136 that is connected to a second resonator.

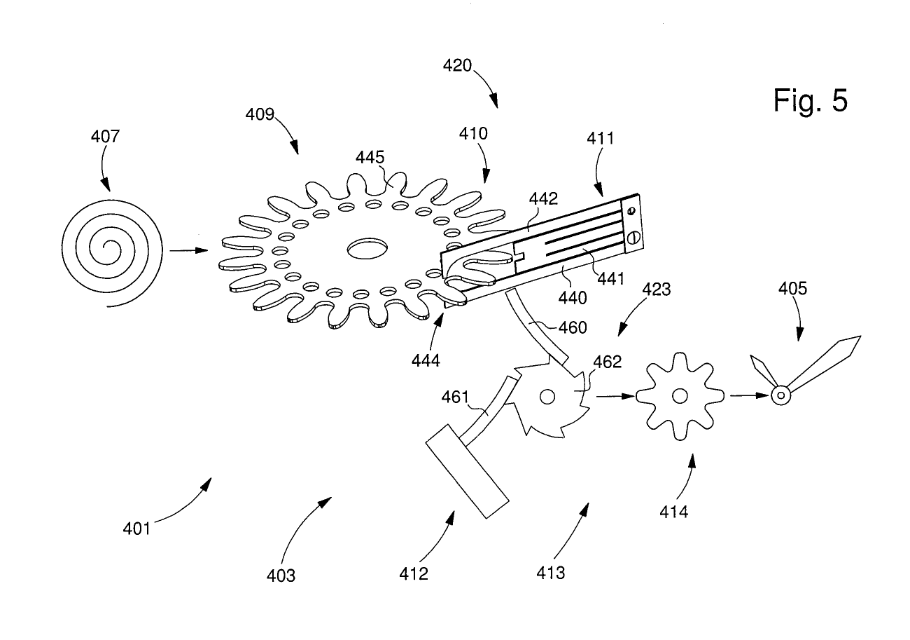

According to a specific alternative, it is also understood that first distribution device 10 and said at least one resonator 11 may also form a one-piece oscillator, that is to say that first distribution device 10 and said at least one resonator 11 are structurally inseparable. By way of example shown in FIG. 5, a one-piece Clifford oscillator 420 is used, as disclosed in CH Patent No 386,344 incorporated by reference into this description. Oscillator 420 comprises a vibrating strip resonator 411 nested with a first magnetic distribution device 410. More specifically, two magnetised arms 440, 442 form a permanent U-shaped magnet 443 intended to cooperate without contact with a wheel 445 connected, directly or indirectly (directly in the case of FIG. 5), to energy source 407. Finally, between the two arms 440, 442 is mounted a vibrating strip 441. To stabilise the frequency of oscillator 420, wheel 445 may also be fitted with an inertial mass.

Of course, said at least one resonator 11, 111, 211, 311 or oscillator 420 are not limited to the examples and specific alternative cited above. Thus, said at least one resonator 11, 111, 211, 311 or oscillator 420 may comprise modifications according to the intended application and/or comprise other types of resonator or oscillator.

Preferably, according to the invention, counting system 13 is chosen for its resistance to shocks. It is therefore understood that counting system 13 may be poor with regard to the transmission of energy as not much energy is required to move display device 5. It is therefore preferred that any shocks suffered by the timepiece are not transmitted to said at least one resonator 11 by counting system 13.

It is observed that second distribution device 12 may be in direct or indirect contact with display device 5. Thus, it is understood that counting system 13 may optionally comprise a transmission train 14 mounted between display device 5 and second distribution device 12.

Counting gear train 14 is dedicated to counting and can be formed by at least two wheel sets cooperating mechanically in order to form reduction means. Of course, counting train 14 should not limited to at least two wheel sets. Thus, counting gear train 14 may comprise modifications according to the intended application and/or comprise other types of energy transmission.

Advantageously according to the invention, a great variety of technology may also be envisaged for second distribution device 12 (type of cooperation with said at least one resonator 11, with or without contact, etc.). Second distribution device 12 comprises counting means 23 making it possible to detect movements of said at least one resonator 11 without transmitting energy to said at least one resonator 11. Since counting system 13 is preferably chosen for its resistance to shocks, counting means 23 are preferably mechanical.

According to a first variant shown in FIG. 2, second distribution device 112 comprises mechanical counting means 123 which are formed by at least one drive lever 160 cooperating with said at least one resonator 111 and driving a wheel 162 cooperating, directly or indirectly (indirectly through gear train 114 in the case of FIG. 3), with display device 105.

The use of a drive lever 160 makes it possible to go without a specific energy source and to directly use the force required to move the display device 105 by the oscillator, that is to say first distribution device 110 cooperating with the resonator 111. The transformation of the oscillations of balance 134 or 137 into rotation of constant direction is ensured by a click which is either a tipping or rotating click.

The operation of such a drive lever is explained notably in the work “Montres Electriques et Electroniques”, by Fédérations des Ecoles Techniques & Jaques Mermod, page 157, IDEA Editions, 1977, which is incorporated by reference into this description.

According to a second variant shown in FIG. 3, second distribution device 212 comprises mechanical counting means 223 which are formed by at least one ratchet 260 cooperating with said at least one resonator 211 and driving a ratchet wheel 262 cooperating, directly or indirectly (indirectly through gear train 214 in the case of FIG. 3), with display device 205. It can also be seen that, to avoid any undesired rotation of ratchet wheel 262, a retention ratchet 261 may be provided.

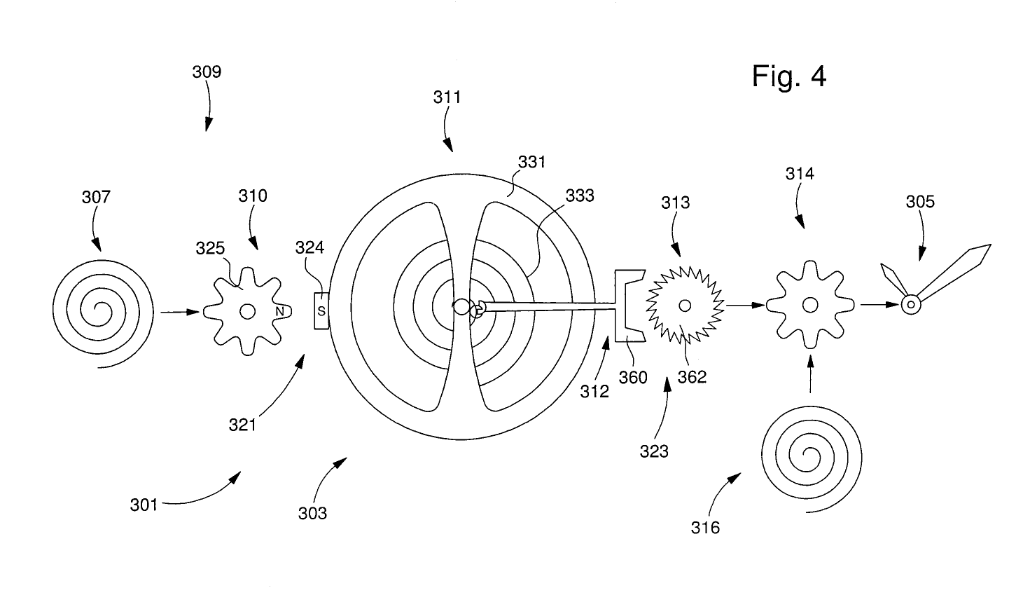

According to a third variant shown in FIG. 4, second distribution device 312 comprises mechanical counting means 323 which are formed by at least one Swiss lever escapement mechanism 360 cooperating with said at least one resonator 311 and driving an escape wheel 362 cooperating, directly or indirectly (indirectly through gear train 314 in the case of FIG. 4), with display device 305 and a second mechanical energy source 316.

Of course, second distribution device 12, 112, 212, 312 should not be limited to the first, second and third variants described above. Thus, distribution device 12, 112, 212, 312 may comprise modifications according to the intended application and/or comprise other types of energy transmission.

Finally, mechanical energy sources 7, 107, 207, 307, 407 and second mechanical energy sources 16, 316 may comprise means for accumulating energy by elastic deformation and/or by pneumatic storage. By way of example, the accumulation means may take the form of a metallic strip mounted in a pivoting drum to form a going barrel.

Four non-limiting embodiments will now be explained to better demonstrate the advantages of this invention with reference to FIGS. 2 to 5.

According to a first embodiment shown in FIG. 2, timepiece 101 comprises a timepiece movement 103 cooperating with a display device 105. Timepiece movement 103 comprises a mechanical energy source 107 formed by a barrel.

The system 109 of energy transmission from energy source 107 to double resonator 111 includes a transmission train 108 and a first distribution device 110 controlled by said double resonator 111. First distribution device 110 comprises electrostatic coupling means 121 formed by at least one electret 124 which is mounted on one of balances 131, 137 of double resonator 111 and which synchronises without contact a selectively polarised wheel 125 cooperating with energy source 107 through transmission train 108 formed by a strain wave gear train.

Double resonator 111 is of the inertia-elasticity type and comprises two sprung balance assemblies. More specifically, the double resonator comprises a first balance 131 cooperating with a first balance spring 133 and a second balance 137 cooperating with a second balance spring 139. Each sprung balance resonator is constructed to have a different frequency and is synchronised with the other by means of a third helical spring formed by a first spiral spring 134 connected to the first resonator and is extended by a raised outer coil 135 to a second spiral spring 136 that is connected to a second resonator.

Counting system 113 is mounted between double resonator 111 and display device 105. Counting system 113 includes a second distribution device 112 controlled by double resonator 111 and comprising mechanical counting means 123 which are formed by at least one drive lever 160 cooperating with double resonator 111 and driving a wheel 162 cooperating with display device 105 via counting train 114.

According to a second embodiment shown in FIG. 3, timepiece 201 comprises a timepiece movement 203 cooperating with a display device 205. Timepiece movement 203 comprises a mechanical energy source 207 formed by a barrel.

The system 209 of energy transmission from energy source 207 to double resonator 211 includes a transmission train 208 and a first distribution device 210 controlled by resonator 211. First distribution device 210 comprises magnetic coupling means 221 formed by at least one permanent magnet 224 mounted on resonator 211, synchronising without contact a wheel 225 cooperating with energy source 207 via transmission train 208 formed by an epicyclic train.

Resonator 211 is of the inertia-elasticity type and is formed by a tuning fork. More specifically, tuning fork 211 comprises two vibrating strips 250, 252 connected to a fixed base 251. Each strip 250, 252 is coupled to one of distribution devices 210, 212 of movement 203.

Counting system 213 is mounted between resonator 211 and display device 205. Counting system 213 includes a second distribution device 212 controlled by resonator 211 and comprising mechanical counting means 223 which are formed by at least one click 260 cooperating with resonator 211 and driving a ratchet wheel 262 cooperating with display device 205 via counting gear train 214. It can also be seen that, to avoid any undesired rotation of ratchet wheel 262, a retention ratchet 261 also cooperates with ratchet wheel 262.

According to a third embodiment shown in FIG. 4, timepiece 301 comprises a timepiece movement 303 cooperating with a display device 305. Timepiece movement 303 comprises a mechanical energy source 307 formed by a barrel.

The energy transmission system 309 from the energy source 307 to the resonator 311 only includes a first distribution device 310 controlled by the resonator 311, that is to say without a driving gear train. The first distribution device 310 comprises magnetic coupling means 321 formed by at least one permanent magnet 324 mounted on the balance 331 of resonator 311 synchronising without contact a wheel 325 cooperating directly with the energy source 307. The resonator 311 is of the inertia-elasticity type and is formed by a balance 331 coupled with a spring 333.

The counting system 313 is mounted between the resonator 311 and the display device 305. Counting system 313 comprises mechanical counting means 323 which are formed by at least one Swiss lever escapement mechanism 360 cooperating with resonator 311 and driving an escape wheel 362 cooperating, via counting gear train 314, with display device 305 and a second mechanical energy source 316.

Finally, according to a fourth embodiment shown in FIG. 5, timepiece 401 comprises a timepiece movement 403 cooperating with a display device 405. Timepiece movement 403 comprises a mechanical energy source 407 formed by a barrel.

The system 409 of energy transmission from energy source 407 to the 411 is inseparable from resonator 411 in that it has not transmission train and in that first distribution device 410 is contained inside resonator 411. It is therefore understood that first distribution device 410 and resonator 411 form a one-piece oscillator 420. In FIG. 5 it can be seen that one-piece oscillator 420 is of the Clifford type and comprises two magnetised arms 440, 442 forming a permanent U-shaped magnet 444 intended to cooperate without contact with a wheel 445 connected directly to energy source 407. Further, between the two arms 440, 442 is mounted a vibrating strip 441.

Counting system 413 is mounted between one-piece oscillator 420 and display device 405. Counting system 413 includes a second distribution device 412 controlled by oscillator 420, such as, for example, its vibrating strip 441, and comprising mechanical counting means 423 which are formed by at least one click 460 cooperating with oscillator 420 and driving a ratchet wheel 462 cooperating with display device 405 via counting gear train 414. It can also be seen that, to avoid any undesired rotation of the ratchet wheel 462, a retention ratchet 461 also cooperates with the ratchet wheel 462.

Of course, this invention is not limited to the illustrated examples but is capable of various variants and modifications that will appear to those skilled in the art. In particular, the coupling means may be of a different type and notably piezoelectric. In a similar manner, the counting means may also be different and notably of the magnetic, electrostatic or piezoelectric type.

Further, the different variants, alternatives and/or embodiments may of course be combined or subject to adaptations according to the intended applications.

What is claimed is:

1. A timepiece comprising a timepiece movement cooperating with a display device, the timepiece movement comprising a mechanical energy source and a system of energy transmission from the energy source to at least one resonator, the energy transmission system including a first distribution device periodically transmitting mechanical energy from the mechanical energy source to the at least one resonator by the movements of the at least one resonator, wherein the timepiece further comprises a counting system mounted between the at least one resonator and the display device, the counting system including a second distribution device cooperating with the display device and counting the movements of the at least one resonator independently with respect to the first distribution device in order to make the energy transmission system totally independent from the counting system.

2. The timepiece according to claim 1, wherein the energy transmission system comprises a transmission train mounted between the energy source and the first distribution device.

3. The timepiece according to claim 2, wherein the transmission train is formed by at least two wheel sets cooperating mechanically so as to form reduction means.

4. The timepiece according to claim 3, wherein the at least two wheel sets cooperate by friction or by meshing.

5. The timepiece according to claim 2, wherein the transmission train is formed by a single reduction gear.

6. The timepiece according to claim 5, wherein the single reduction gear is an epicyclic gear train or a strain wave gear train.

7. The timepiece according to claim 1, wherein the first distribution device comprises coupling means making it possible, by the movement of the at least one resonator, to transmit part of the energy from the energy source.

8. The timepiece according to claim 7, wherein the coupling means are of the magnetic type.

9. The timepiece according to claim 8, wherein the coupling means of the magnetic type are formed by at least one permanent magnet mounted on the at least one resonator synchronising without contact a wheel cooperating, directly or indirectly, with the energy source.

10. The timepiece according to claim 7, wherein the coupling means are of the electrostatic type.

11. The timepiece according to claim 10, wherein the coupling means of the electrostatic type are formed by at least one electret (124) mounted on the at least one resonator and synchronising without contact a wheel cooperating, directly or indirectly, with the energy source.

12. The timepiece according to claim 7, wherein the coupling means are formed by an escapement mechanism.

13. The timepiece according to claim 12, wherein the escapement mechanism is of the Swiss lever, the coaxial or the detent type, the escapement mechanism comprising an escape wheel that cooperates, directly or indirectly, with the energy source.

14. The timepiece according to claim 1, wherein the at least one resonator is of the inertia-elasticity type.

15. The timepiece according to claim 14, wherein the at least one resonator of the inertia-elasticity type is an assembly comprising a balance and a balance spring, a vibrating strip or a tuning fork.

16. The timepiece according to claim 1, wherein the at least one resonator comprises several resonators coupled together.

17. The timepiece according to claim 1, wherein the first distribution device and the at least one resonator form a one-piece oscillator.

18. The timepiece according to claim 17, wherein the one-piece oscillator is of the Clifford type.

19. The timepiece according to claim 1, wherein the counting system comprises a counting gear train mounted between the display device and the second distribution device.

20. The timepiece according to claim 19, wherein the counting gear train is formed by at least two wheel sets cooperating mechanically so as to form reduction means.

21. The timepiece according to claim 1, wherein the second distribution device comprises counting means making it possible to detect movements of the at least one resonator, without transmitting energy to the at least one resonator.

22. The timepiece according to claim 21, wherein the counting means are of the mechanical type.

23. The timepiece according to claim 22, wherein the counting means of the mechanical type are formed by at least one drive lever cooperating with the at least one resonator and driving a wheel cooperating, directly or indirectly, with the display device.

24. The timepiece according to claim 22, wherein the counting means of the mechanical type are formed by at least one ratchet cooperating with the at least one resonator and driving a ratchet wheel cooperating, directly or indirectly, with the display device.

25. The timepiece according to claim 22, wherein the counting means of the mechanical type are formed by at least one escapement mechanism cooperating with the at least one resonator and driving a wheel cooperating, directly or indirectly, with the display device and a second mechanical energy source.

26. The timepiece according to claim 1, wherein each mechanical energy source comprises means for accumulating energy by elastic deformation or by pneumatic storage.

27. The timepiece according to claim 1, wherein the display device comprises a hand and/or disc type display member.
